(19) United States
(12) Patent Application Publication
(10) Pub. No.: US 2011/0068573 A1
(43) Pub. Date: Mar. 24, 2011

(54) PIPE JOINT

(75) Inventors: Masaaki Muto, Ibaraki (JP); Hiroshi Hanne, Ibaraki (JP); Kouichirou Ishibashi, Ibaraki (JP)

(73) Assignee: SMC CORPORATION, CHIYODA-KU (JP)

(21) Appl. No.: 12/992,717

(22) PCT Filed: Jun. 12, 2008
(86) PCT No.: PCT/JP08/60787

§ 371 Date: Nov. 15, 2010

(51) Int. Cl. F16L 37/00

(52) U.S. Cl. 285/313

(57) ABSTRACT

[Object] A pipe joint is to be provided that prevents a release bush from being accidentally pressed, and that inhibits the tube from being removed from the pipe joint unless a worker uses a predetermined tool with the intention of removing the tube from the pipe joint.

[Solution] In a pipe joint including a chuck 21 with a latch claw to be engaged with an outer circumferential surface of a tube T inserted in the pipe joint thereby retaining the tube, a release bush 5 to be inwardly pressed along the tube inserted through the chuck so as to disengage the chuck from the tube is configured so as to inhibit direct manipulation thereof from outside of a main body 1 of the pipe joint, and a pressing tool 7 that can inwardly press the release bush into a position where the release bush disengages the chuck from the tube is provided as a separate member.

### TECHNICAL FIELD

The present invention relates to a pipe joint that connects a hydraulic apparatus and a piping tube in a pneumatic circuit or the like.

### BACKGROUND ART

A pipe joint for connecting a hydraulic apparatus and a piping tube in a pneumatic circuit or the like, that includes a fluid channel formed through a central portion of its main body and in which a tube retention mechanism and a release bush are mounted, is widely known and therefore citing a specific example is unnecessary. The tube retention mechanism is attached to an end portion of the fluid channel, and includes a chuck with a latch claw to be engaged with the outer circumferential surface of a tube inserted therein so as to retain the tube, and the release bush serves to disengage the chuck from the tube upon being pressed into the chuck, thereby allowing the tube to be removed.

In the pipe joint thus configured, the release bush effectively works for the removal of the tube in the case, for example, where the tube has to be removed for modifying the pipe connection or correcting erroneous piping. However, there are sites where the pipe connection is rarely modified after once properly connecting the piping tube to the hydraulic apparatus and, moreover, since the release bush is located at a position where it can be easily accessed, the release bush of the properly connected pipe joint is prone to be accidentally pressed resulting in removal of the properly connected piping tube, during such work as connecting or disconnecting a tube to or from another pipe joint close to the properly connected pipe joint.

### DISCLOSURE OF THE INVENTION

### Problems to be Solved by the Invention

Accordingly, an object of the invention is to provide a pipe joint that prevents the release bush from being accidentally pressed, and that inhibits the tube from being removed from the pipe joint unless a worker uses a predetermined tool with an intention to remove the tube from the pipe joint, yet allows the worker to remove the tube by performing a simple operation.

### Means for Solving the Problems

In one aspect, the invention provides a pipe joint including a tube retention mechanism provided at an end portion of a fluid channel formed through a main body of the pipe joint, the tube retention mechanism including a chuck with a latch claw to be engaged with an outer circumferential surface of a tube inserted into the fluid channel so as to retain the tube; a release bush to be inwardly pressed along the tube inserted in the chuck so as to disengage the chuck from the tube thereby allowing the tube to be removed, the release bush being located so as not to protrude from the main body; and a cylindrical pressing tool that allows the release bush to be inwardly pressed to a position where the release bush disengages the chuck from the tube, the cylindrical pressing tool being a member provided separately from the main body.

It is preferable that the pressing tool for the release bush is constituted of a pair of semi-cylindrical tool pieces that can be coupled in a cylindrical shape, or is a tool that can be fitted onto the tube by elastic deformation.

In another aspect, the invention provides a pipe joint including a tube retention mechanism provided at an end portion of a fluid channel formed through a main body of the pipe joint, the tube retention mechanism including a chuck with a latch claw to be engaged with an outer circumferential surface of a tube inserted into the fluid channel so as to retain the tube; a release bush to be inwardly pressed along the tube inserted in the chuck so as to disengage the chuck from the tube thereby allowing the tube to be removed, the release bush including a protruding portion sticking out from the main body, to be inwardly pressed by a pressing tool fitted onto the tube, so that the release bush is pressed into the main body to reach a position where the release bush disengages the chuck from the tube, the protruding portion being formed in a shape that cannot be directly manipulated by a finger; wherein the pressing tool is a separate member of an annular shape, and can be engaged with the protruding portion so as to inwardly press the release bush to the position where the release bush disengages the chuck from the tube.

It is preferable that the pressing tool for the release bush is constituted of a pair of semi-annular elements that can be coupled in a circular shape.

In still another aspect, the invention provides a pipe joint including a tube retention mechanism provided at an end portion of a fluid channel formed through a main body of the pipe joint, the tube retention mechanism including a chuck with a latch claw to be engaged with an outer circumferential surface of a tube inserted into the fluid channel so as to retain the tube; a release bush to be inwardly pressed along the tube inserted in the chuck so as to disengage the chuck from the tube thereby allowing the tube to be removed, the release bush being a member provided separately from the main body to be removably attached thereto, and to be fitted onto the tube and inserted into the position where the release bush disengages the chuck from the tube.

It is preferable that the release bush is constituted of a pair of semi-cylindrical release bush elements that can be coupled in a cylindrical shape.

In the pipe joint thus configured, since the release bush is located at a position inaccessible by a finger of a worker or another object, the release bush is barely likely to be subjected to a force that presses the release bush inwardly into the main body (so as to remove the tube), and hence there is little likelihood that the chuck accidentally becomes disengaged from the tube.

On the other hand, simply by fitting the pressing tool or the additional release bush onto the tube and inserting the pressing tool or the additional release bush into the main body, the chuck can be easily disengaged from the outer circumferential surface of the tube, as in the case of utilizing the conventional release bush, for free removal of the tube from the main body.

### ADVANTAGES

In the foregoing pipe joint according to the invention the release bush is not provided in an accessible position, which prevents the release bush from being accidentally pressed, thereby disabling the tube from being removed unless the worker uses a predetermined tool with the intention of removing the tube from the pipe joint. However, the removal with a predetermined tool can be easily carried out.

### BRIEF DESCRIPTION OF THE DRAWINGS

FIG. 1 is a vertical cross-sectional view of a pipe joint according to a first embodiment of the invention.

FIG. 2 is a partially cross-sectional front view of a tube retention mechanism employed in the first embodiment and a second embodiment.

FIG. 3 is a bottom view of the tube retention mechanism.

FIG. 4(a) is a perspective view showing an example of a pressing tool for a release bush employed in the first embodiment.

FIG. 4(b) is a perspective view showing another example of the pressing tool.

FIG. 5 is a vertical cross-sectional view of a pipe joint according to the second embodiment of the invention.

FIG. 6 is a side view of the release bush according to the second embodiment.

FIG. 7 is a perspective view showing an example of the pressing tool for the release bush employed in the second embodiment.

FIG. 8 is a perspective view showing a release bush additionally provided for the pipe joint according to a third embodiment of the invention.

### REFERENCE NUMERALS

1 main body
2 tube retention mechanism
5 release bush
7 pressing tool
11 fluid channel
13 tube insertion clearance
21 chuck
24 latch claw
51 cylindrical portion
54 projecting portion
T tube

### BEST MODES FOR CARRYING OUT THE INVENTION

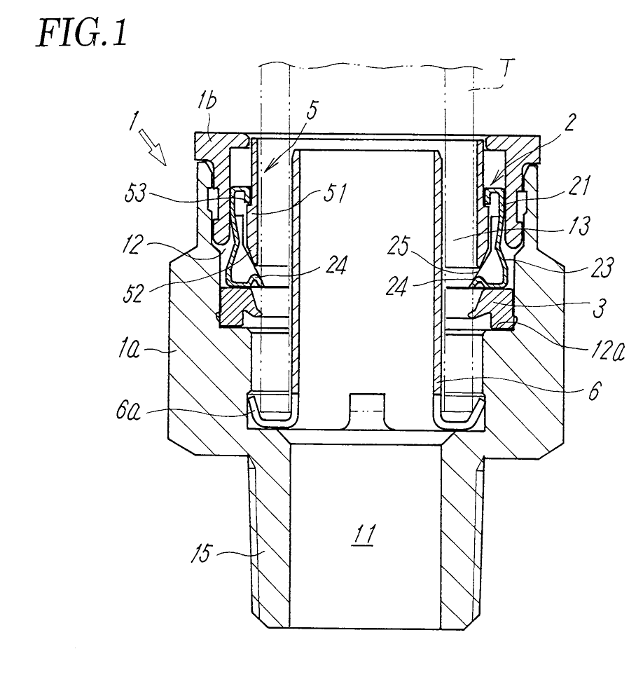

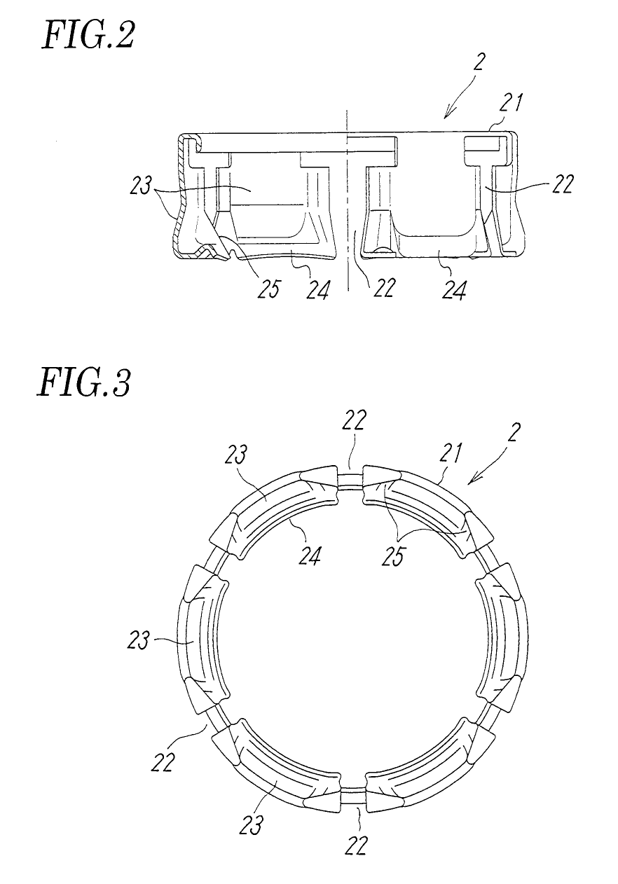

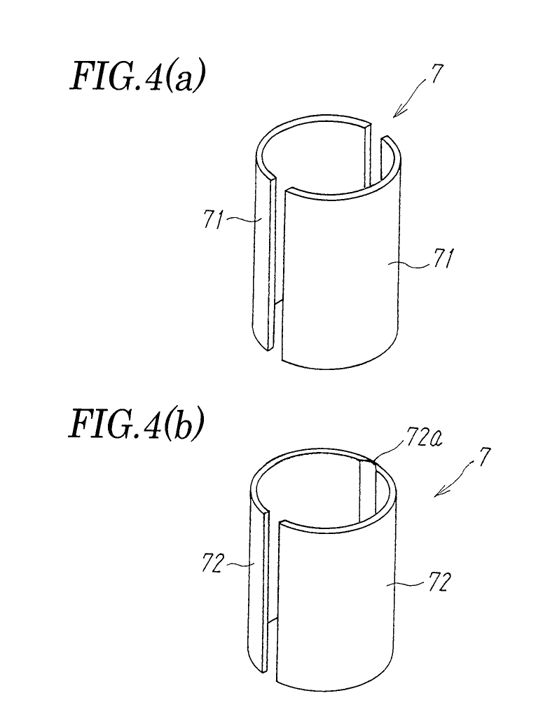

FIG. 1 depicts a pipe joint according to a first embodiment of the invention; FIGS. 2 and 3 show details of a tube retention mechanism employed in the first embodiment; and FIGS. 4(a) and 4(b) show an example of a pressing tool for a release bush employed in the first embodiment.

In outline, the pipe joint according to the first embodiment includes a main body 1 constituting the outer shell of the pipe joint, a tube retention mechanism 2 mounted in the main body 1 for retaining an end portion of a tube T, an elastic seal member 3 provided inside the main body 1, a release bush 5 that serves to disengage the tube retention mechanism 2 from the tube T thereby retained, and a receiving tube 6 that receives the tube T inserted in the main body 1 upon fitting the end portion of the tube T onto the receiving tube 6.

The main body 1 includes a fluid channel 11 formed so as to penetrate therethrough along an axial center thereof, so that a fluid can flow between the tube T and a hydraulic apparatus to which the tube T is connected. The main body 1 also includes a guide member 1b with a flange formed at an end portion thereof, press-fitted to an end portion of a main portion 1a of the main body 1 through which the fluid channel 11 is provided, and the guide member 1b thus press-fitted defines a larger-diameter region 12 around the fluid channel 11 inside the main portion 1a. A deeper portion of the larger-diameter region 12 serves as a location for the seal member 3 while a portion thereof closer to the guide member 1b for the tube retention mechanism 2, and a space between these locations and the fluid channel 11 constitutes an insertion clearance 13 for the tube T. The outer circumferential surface of the other end portion of the main body 1 is formed as a mounting screw 15 for connection to the hydraulic apparatus.

The elastic seal member 3 provided inside the larger-diameter region 12 is located between the tube retention mechanism 2 and a stepped portion 12a in the larger-diameter region 12, so as to enter into contact with the outer circumferential surface of the tube T inserted in the insertion clearance 13 around the fluid channel 11, thereby serving as a seal between the outer circumferential surface of the tube T and the inner wall of the larger-diameter region 12. The elastic seal member 3 contributes to minimizing a leak between the tube T and the fluid channel 11 in the main body 1.

The tube retention mechanism 2 is constituted of a metal chuck 21 including a plurality of latch claws 24 to be engaged with the outer circumferential surface of the tube T inserted in the main body 1. The chuck 21 includes, as shown in FIGS. 2 and 3, a plurality of slits 22 formed on an end portion of a cylindrical member made of a metal plate, and the slits 22 define a plurality of elastic elements 23 that are radially elastic, aligned along the circumference of the cylindrical member. The tip portion of the respective elastic elements 23 oriented to a deeper portion of the tube insertion clearance 13 is inwardly bent so as to form the latch claw 24 projecting into the tube insertion clearance 13, and the elastic elements 23 each include a sloped pressing element 25 that press-opens the latch claw 24 engaged with the outer circumferential surface of the tube T, when a cylindrical portion 51 (to be described later) of the release bush 5 for disengaging the chuck 21 from the tube T is inserted in the chuck 21 and the cylindrical portion 51 of the release bush 5 is pressed against the sloped pressing element 25. Here, the chuck 21 may be held by a collet (not shown) if need be.

The receiving tube 6, on which the end portion of the tube T inserted in the main body 1 is to be fitted, constitutes a partition between the fluid channel 11 and the tube insertion clearance 13, and includes a flange portion 6a formed by partially bending outwardly an end portion of a metal tube. The flange portion 6a is made to abut the inner end of the tube insertion clearance 13, so that the receiving tube 6 is elastically retained inside the main portion 1a of the main body 1 via the portion of the receiving tube 6 around the flange portion 6a. The receiving tube 6 serves to stabilize the position of the end portion of the tube T fitted thereon, and extends from the flange portion 6a at least to a position opposing the latch claw 24 of the chuck 21, so as to sustain a radial pressure applied to the tube T by the latch claw 24, thereby stabilizing the engagement therebetween.

Whereas the release bush 5, inserted between the tube insertion clearance 13 and the chuck 21 inside the main body 1, serves to disengage the chuck 21 from the tube T upon being inserted deeper into the main body 1 thereby allowing the tube T to be removed, the release bush 5 is disposed so as not to protrude from the main body 1 according to this embodiment, in order to prevent the tube T from being unintentionally or unduly removed by the release bush 5. To be more specific, the release bush 5 is constituted of a cylindrical member 51 formed so as to correspond to the outer circumference of the tube insertion clearance 13 in the main body 1, and the outer circumferential surface of the inner end portion of the cylindrical member 51 is tapered toward the end portion so as to form a tapered surface 52, which serves to press-open the latch claw 24 engaged with the outer circumferential surface of the tube T thus to allow the tube T to be removed. Here, the cylindrical member 51 is formed so as not to protrude outward from the main body 1, and includes a stepped portion 53 formed on the outer surface thereof so as to be engaged with a folded portion formed at the upper end of the chuck 21 when the release bush 5 is inserted in the main body 1, thereby preventing the release bush 5 from coming off from the main body 1.

Now, for disengaging the chuck 21 from the tube T with the release bush 5 configured as above, a cylindrical pressing tool 7 as shown in FIGS. 4(a) and 4(b) is provided as a separate accessory. The cylindrical pressing tool 7 is utilized to press the release bush 5 into the position where the release bush 5 disengages the chuck 21, in other words to the position where the tapered surface 52 of the release bush 5 is pressed against the sloped pressing element 25 of the chuck 21 such that the sloped pressing element 25 press-opens the latch claw 24 engaged with the tube T.

The pressing tool 7 for the release bush 5 shown in FIG. 4(a) is constituted of a pair of semi-cylindrical tool pieces 71 made of a metal or a synthetic resin, that can be coupled in a cylindrical shape upon being fitted onto the tube T, so that the end face of the tool pieces 71 can be made to abut the outer end face of the release bush 5 and press it inward through an opening in the end portion of the main body 1. The pressing tool 7 shown in FIG. 4(b) is constituted of a pair of semi-cylindrical pieces 72 made of a synthetic resin, connected to each other via an elastically deformable thinner portion 72a so that the semi-cylindrical pieces 72 can be opened about the thinner portion 72a so as to be fitted onto the tube T.

It is to be noted that the pressing tool 7 may be formed in various other ways than the foregoing examples, as long as the design allows the pressing tool 7 to inwardly press the release bush 5. To cite a few examples, an elastically deformable thin plate may be rolled around the tube T, or an elastically deformable arcuate member larger than the semi-cylinder but not fully circular may be fitted onto the tube T.

With the pipe joint configured as above, when the tube T is inserted in the tube insertion clearance 13 in the state shown in FIG. 1, the latch claw 24 of the chuck 21 becomes engaged with the surface of the tube T, so that the tube T is retained in the inserted state. To remove the tube T thus retained, the pressing tool 7 for the release bush 5 is fitted onto the tube T to press the outer end portion of the release bush 5 inward via the end face of the pressing tool 7, into the position where the release bush 5 press-opens the latch claw 24 engaged with the tube T, so as to disengage the chuck 21, thereby allowing the tube T to be removed. It is to be noted that unless the pressing tool 7 is employed the release bush 5 cannot be pressed deeper into the main body 1, and therefore the chuck 21 is kept from being disengaged from the tube T.

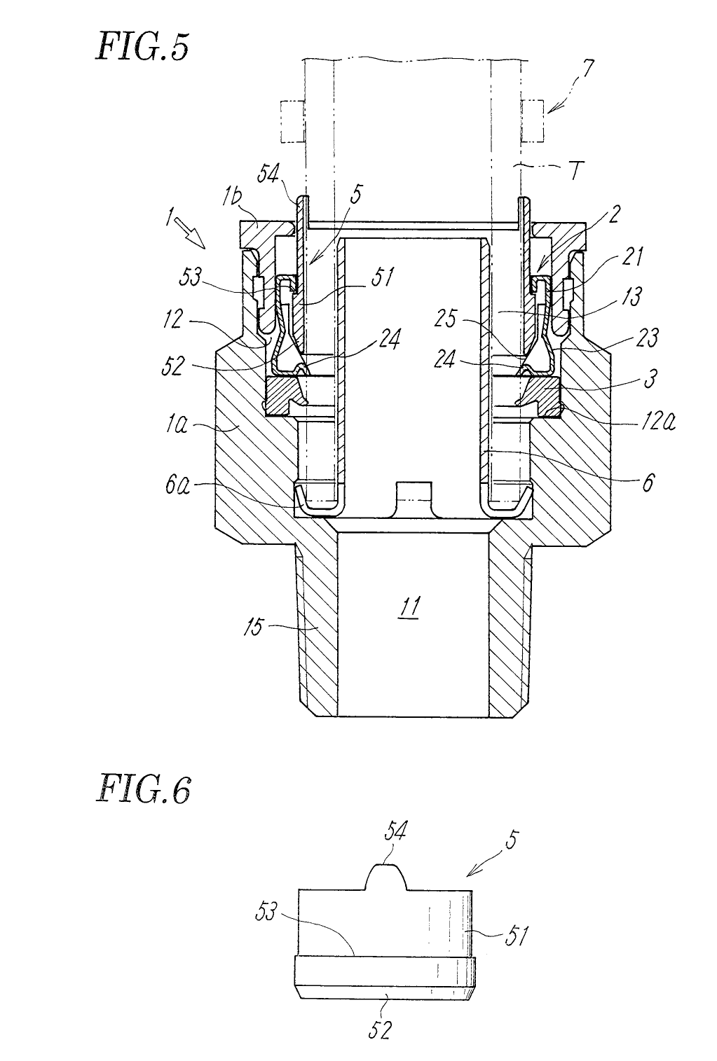

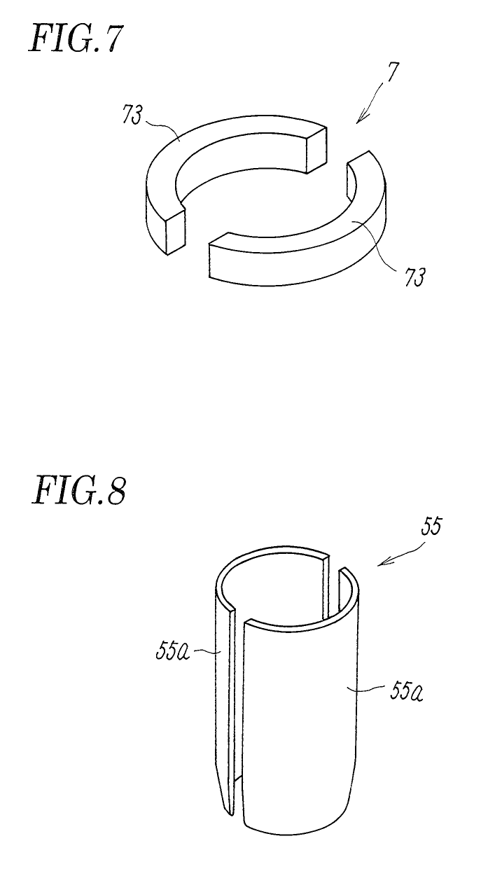

FIG. 5 depicts a pipe joint according to a second embodiment of the invention; FIG. 6 shows a configuration of the release bush employed in the pipe joint; and FIG. 7 shows an example of the pressing tool employed in the second embodiment.

The pipe joint according to the second embodiment is different from that of the first embodiment only in the configuration of the release bush 5 and the pressing tool 7, and hence the description of the remaining portion will not be repeated.

As is apparent from FIGS. 5 and 6, the release bush 5 according to the second embodiment is constituted of the cylindrical member 51 including the tapered surface 52 and the stepped portion 53 to be engaged with the folded portion formed at the upper end portion of the chuck 21, as in the first embodiment, while the difference from the first embodiment lies in that the release bush 5 includes a protruding portion 54 that sticks out from the main body 1. The protruding portion 54 is pressed inwardly into the main body 1 by an annular pressing tool 7 as shown in FIG. 7 to be fitted onto the tube T, so that the release bush 5 reaches the position where the release bush 5 disengages the chuck 21 from the tube T. Here, the protruding portion 54 is formed with a very small, pointed, or very thin facet to be pressed, so that the protruding portion 54 cannot be directly manipulated with a finger. Although the protruding portion 54 must have a sufficient height from the main body 1 that allows the release bush 5 to be pressed as far as the position where the release bush 5 disengages the chuck 21 from the tube T, it is preferable to form the protruding portion 54 in a minimum necessary height.

As shown in FIG. 7, it is preferable that the pressing tool 7 to be engaged with the protruding portion 54 to inwardly press the release bush 5 into the position where the release bush 5 disengages the chuck 21, is constituted of a pair of semi-annular elements 73 as a separate accessory, to be fitted around the tube T in a ring shape and thus to press the protruding portion 54 of the release bush 5 sticking out from the main body 1 with the end face of the semi-annular elements 73. It is preferable to form the pair of semi-annular elements 73 in a size slightly smaller than a half of a full circle, so that upon fitting the pair around the tube T the tube T is slightly press-deformed, so as to ensure that the pair of semi-annular elements 73 is properly made to abut the end portion of the protruding portion 54.

The configuration and operation of the pipe joint according to the second embodiment other than the foregoing are the same as those of the first embodiment.

The pipe joint according to a third embodiment of the invention is different from that of the first embodiment in that the release bush 5 is excluded and that instead a release bush 55 as shown in FIG. 8 is provided as a separate accessory that can be removably attached to the main body 1. The release bush 55 is formed in such a length that a manipulating portion sticks out from the main body 1. The configuration and operation of the pipe joint other than the foregoing are the same as those of the first embodiment, and therefore the description thereof will not be repeated.

The release bush 55 serves to disengage the chuck 21 from the tube T upon being inserted along the portion of the tube T inserted in the chuck 21, thereby allowing the tube T to be removed and, as shown in FIG. 8, is constituted of a pair of semi-cylindrical release bush elements 55a to be coupled in a cylindrical shape. To remove the tube T from the pipe joint, the release bush elements 55a are fitted onto the tube T outside the main body 1 so as to cover the same, and pressed inwardly into the position where the release bush elements 55a disengage the latch claw 24, hence the chuck 21, from the tube T. Since the release bush 55 is removable from the main body 1 and usually not attached to the main body 1, and therefore the tube T can be prevented from being accidentally removed.

1. A pipe joint comprising:
a tube retention mechanism provided at an end portion of a fluid channel formed through a main body of the pipe joint, the tube retention mechanism including a chuck with a latch claw to be engaged with an outer circumferential surface of a tube inserted into the fluid channel so as to retain the tube;
a release bush to be inwardly pressed along the tube inserted in the chuck so as to disengage the chuck from the tube thereby allowing the tube to be removed, the release bush being located so as not to protrude from the main body; and
a cylindrical pressing tool that allows the release bush to be inwardly pressed to a position where the release bush disengages the chuck from the tube, the cylindrical pressing tool being a member provided separately from the main body.

2. The pipe joint according to claim 1,
wherein the pressing tool for the release bush is constituted of a pair of semi-cylindrical tool pieces that can be coupled in a cylindrical shape, or is a tool that can be fitted onto the tube by elastic deformation.

3. A pipe joint comprising:
a tube retention mechanism provided at an end portion of a fluid channel formed through a main body of the pipe joint, the tube retention mechanism including a chuck with a latch claw to be engaged with an outer circumferential surface of a tube inserted into the fluid channel so as to retain the tube;
a release bush to be inwardly pressed along the tube inserted in the chuck so as to disengage the chuck from the tube thereby allowing the tube to be removed, the release bush including a protruding portion sticking out from the main body, to be inwardly pressed by a pressing tool fitted onto the tube so that the release bush is pressed into the main body to reach a position where the release bush disengages the chuck from the tube, the protruding portion being formed in a shape that cannot be directly manipulated by a finger;
wherein the pressing tool is a separate member of an annular shape, and can be engaged with the protruding portion so as to inwardly press the release bush to the position where the release bush disengages the chuck from the tube.

4. The pipe joint according to claim 3,
wherein the pressing tool for the release bush is constituted of a pair of semi-annular elements that can be coupled in a circular shape.

5. A pipe joint comprising:
a tube retention mechanism provided at an end portion of a fluid channel formed through a main body of the pipe joint, the tube retention mechanism including a chuck with a latch claw to be engaged with an outer circumferential surface of a tube inserted into the fluid channel so as to retain the tube;
a release bush to be inwardly pressed along the tube inserted in the chuck so as to disengage the chuck from the tube thereby allowing the tube to be removed, the release bush being a member provided separately from the main body to be removably attached thereto, and to be fitted onto the tube and inserted into a position where the release bush disengages the chuck from the tube.

6. The pipe joint according to claim 5,
wherein the release bush is constituted of a pair of semi-cylindrical release bush elements that can be coupled in a cylindrical shape.
